(19) United States
(12) Patent Application Publication
(10) Pub. No.: US 2018/0123686 A1
(43) Pub. Date: May 3, 2018

(54) SECURE OPTICAL NETWORK TAP

(71) Applicant: Ixia, Calabasas, CA (US)

(72) Inventors: Randy Fung, San Jose, CA (US); Marcel Felix Desdier, Pleasanton, CA (US); Jonathan Worthington Petkevich, Holly Springs, NC (US)

(21) Appl. No.: 15/603,426

(22) Filed: May 23, 2017

Related U.S. Application Data
(60) Provisional application No. 62/414,400, filed on Oct. 28, 2016.

(51) Int. Cl. H04B 10/071; H04B 10/25; H04B 10/079; H04B 10/27

(52) U.S. Cl. CPC H04B 10/071; H04B 10/27; H04B 10/0793; H04B 10/2503

(57) ABSTRACT

A secure optical network tap includes first and second network ports for bidirectional exchange of optical signals. The tap further includes at least one monitor port for monitoring optical signals received on the first and second network ports. The tap further includes first and second optical couplers coupled to the first and second network ports for bidirectional exchange of the monitored optical signals between the network ports and between the network ports and the monitor port. The tap further includes at least one one-way optical blocking device for preventing the flow of optical signals from the monitor port to the first and second network ports and for allowing the monitored optical signals to flow from the optical couplers to the at least one monitor port.

### PRIORITY CLAIM

This application claims the priority benefit of U.S. Provisional Patent Application No. 62/414,400, filed Oct. 28, 2016, the disclosure of which is incorporated herein by reference in its entirety.

### TECHNICAL FIELD

The subject matter described herein relates to optical network taps. More particularly, the subject matter described herein relates to a secure optical network tap where the flow of optical signals from the monitoring network to the monitored network is blocked or prevented.

### BACKGROUND

Optical network taps are used to tap optical signals from monitored networks to a monitoring network. A typical optical network tap includes one or more optical network ports and one or more monitor ports. One problem with current optical network taps is that all of the ports, including the monitor ports, are bidirectional. As a result, data could flow back from the monitoring network to the monitored network.

FIG. 1 illustrates the possible issue of data flowing from the monitoring network into the monitored network. Referring to FIG. 1, an optical network tap 100 includes network ports 102 and 104 and a monitor port 106. Network ports 102 and 104 are connected to monitored networks 108 and 110. Monitor port 106 is connected to monitoring network 112. Optical couplers 114 and 116 are connected between network ports 102 and 104 and monitor port 106. Optical couplers 114 and 116 provide optical signals from monitored networks 108 and 110 to monitoring network 112 via monitor port 106. However, optical couplers 114 and 116 also allow traffic from monitoring network 112 to networks 108 and 110, which may be undesirable. For example if a data cable with outgoing data from monitoring network 112 is accidentally or maliciously connected to monitor port 106, the data would flow through optical network tap 100 into monitoring networks 108 and 110, as indicated by the dashed arrows in FIG. 1.

Accordingly, there exists a need for a secure optical network tap.

### SUMMARY

A secure optical network tap includes first and second network ports for bidirectional exchange of optical signals. The tap further includes at least one monitor port for monitoring optical signals received on the first and second network ports. The tap further includes first and second optical couplers coupled to the first and second network ports for bidirectional exchange of the monitored optical signals between the network ports and between the network ports and the monitor port. The tap further includes at least one one-way optical blocking device for preventing the flow of optical signals from the monitor port to the first and second network ports and for allowing the monitored optical signals to flow from the optical couplers to the at least one monitor port.

### BRIEF DESCRIPTION OF THE DRAWINGS

The subject matter described herein will now be explained with reference to the accompanying drawings of which:

FIG. 1 is a block diagram of a conventional network tap;

FIG. 2 is a block diagram of a secure network tap;

FIG. 3 is a diagram of an optical isolator;

FIG. 4 is a diagram of an optical circulator; and

FIG. 5 is a flow chart illustrating an exemplary method for securely tapping an optical network using a secure optical network tap.

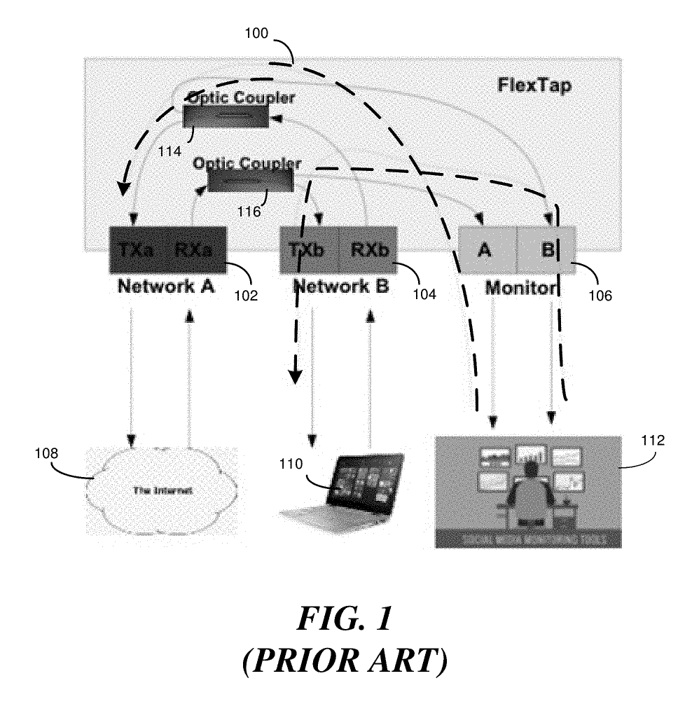

### DETAILED DESCRIPTION

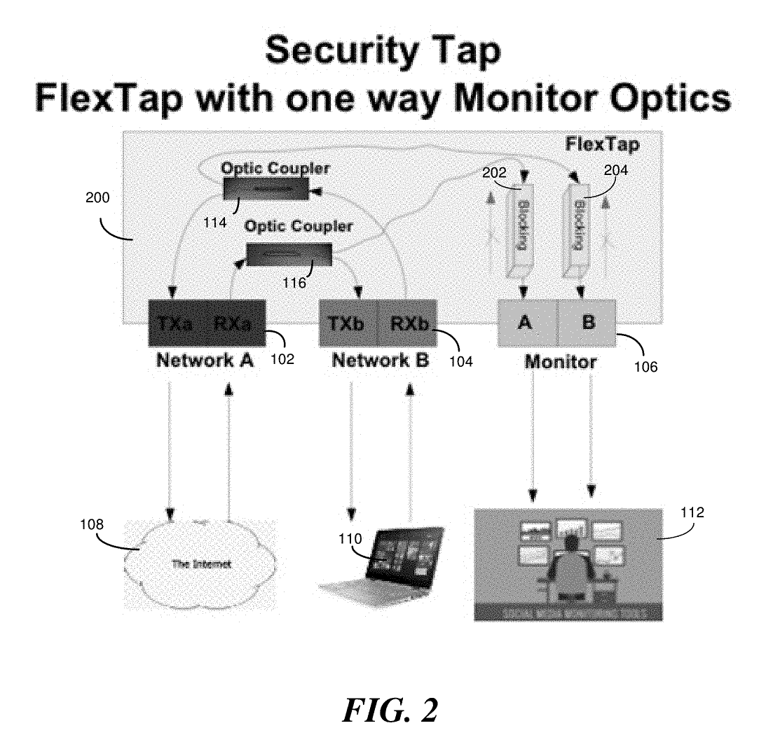

As stated above, it may be desirable to prevent the flow of optical signals from a monitoring network to monitored networks. FIG. 2 is a block diagram illustrating a secure optical tap that prevents such data flow. In FIG. 2, an optical network tap 200 includes network ports 102 and 104 and monitor port 106, as described above. In addition, optical network tap 200 includes optical couplers 114 and 116 connected between network ports 102 and 104 and monitor port 106. In the illustrated example, each optical coupler 114 and 116 comprises a splitter that splits the signal received from one network and provides the signal to the outbound network and to monitor port 106.

To prevent the flow of optical signals from monitoring network 112 to monitored networks 108 and 110, optical blocking devices 202 and 204 may be provided. Optical blocking devices 202 and 204 allow optical signals to pass from network ports 102 and 104 to monitor port 106. However, blocking devices 202 preferably prevent the flow of optical data from monitor port 106 to network ports 102 and 104.

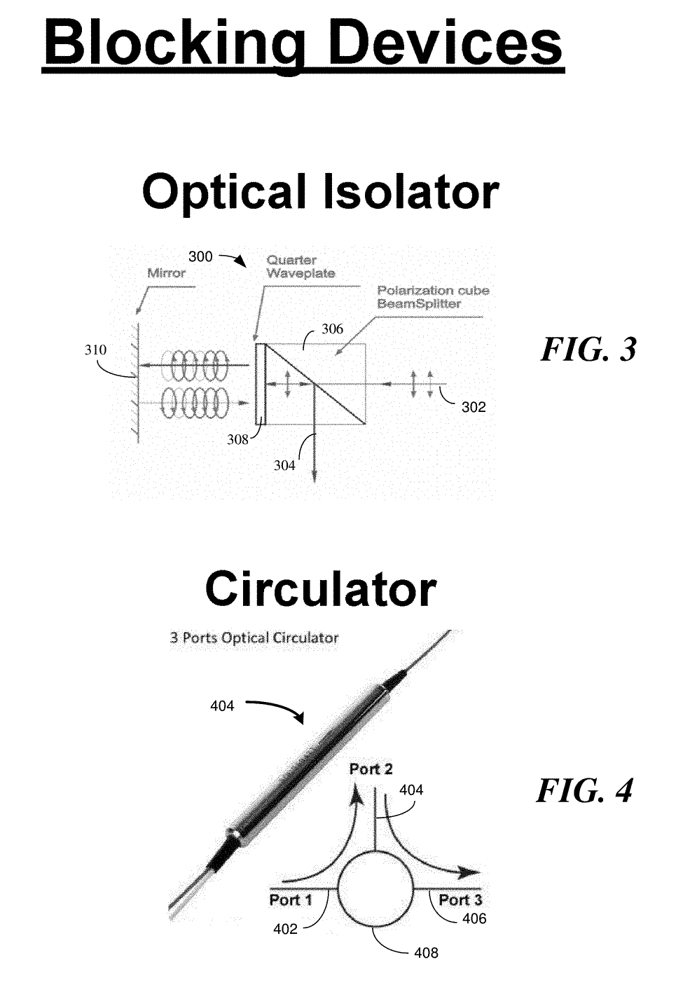

FIG. 3 is a diagram illustrating an example of an optical isolator suitable for use as blocking devices 202 and 204. In the illustrated example, optical isolator 300 includes an input port 302 that may be connected to one of optical couplers 114 and 116. Optical isolator 300 further includes an output port 304 that may be connected to monitor port 106. A polarization cube and beam splitter 306 allows optical signals to flow from input port 302 to a quarter wave plate 308 and to mirror 310, which reflects the signals back through quarter wave plate 308 and beam splitter 306 to output port 304. Quarter wave plate 308 converts linearly polarized input signals to circularly polarized signals. Mirror 310 reverses the polarization direction of the received circularly polarized signals. However, signals from output port 304 will be totally internally reflected within beam splitter 306 and will be prevented from flowing back to input port 302. Thus, optical isolator 300 may perform as a one-way optical device that allows or passes optical signals from network ports 102 and 104 to monitor port 106 but not from monitor port 106 to network ports 102 and 104.

FIG. 4 is a diagram of a three-port optical circulator that is also suitable for use as blocking devices 202 and 204. In FIG. 4, three port optical circulator 400 includes an input port 402, two output ports 404 and 406, and a circulator 408. In order to function as blocking devices 202, input port 402 may be connected to one of optical couplers 114 and 116 and output port 406 may be connected to monitor port 106. Output port 404 would be unconnected or non-terminated such that signal from input port 402 will be reflected from the open termination to output port 406 but not from output port 406 to input port 402. Thus, three-port optical circulator 400 likewise functions as a one-way optical valve that allows flow of optical signals from the network ports to the monitor port but not from the monitor port to the network port.

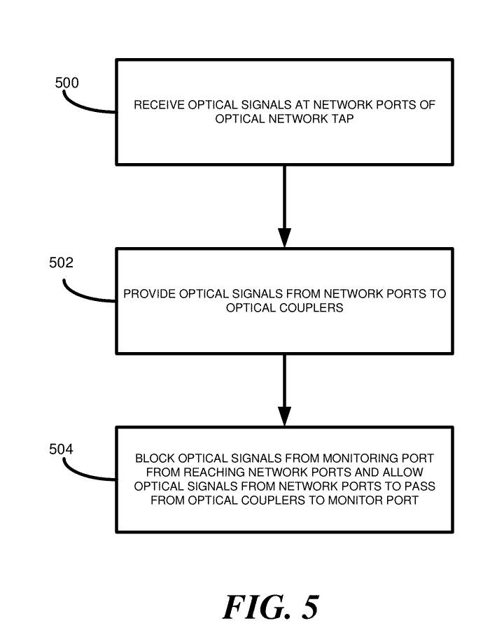

FIG. 5 is a flow chart illustrating an exemplary process for secure optical network tapping. Referring to FIG. 5, in step 500, optical signals are received at network ports of an optical network tap. For example, optical signals may be received at network ports 102 and 104 of optical network tap 200 illustrated in FIG. 2. In step 502, the signals are provided to optical couplers of the optical network tap. For example, optical signals received at network ports 102 and 104 may be provided to optical couplers 114 and 116. In step 504, optical signals from the monitor port are prevented or blocked from being transmitted to the network port. For example, blocking devices 202 and 204 may block the flow of signals from monitor port 106 to network ports 102 and 104. In addition, optical signals from the network ports are allowed to pass from the optical couplers to the monitor port. For example, optical signals from network ports 102 and 104 are allowed to pass from optical couplers 114 and 116 to monitor port 106.

Although in the example illustrated in FIG. 2, the optical network tap includes one monitor port and two network ports. The subject matter described herein is not limited to such an implementation. Any number of network ports and monitor ports in a secure optical network tap arrangement is intended to be within the scope of the subject matter described herein.

In addition, in the example illustrated in FIG. 2, separate blocking devices 204 and 204 are illustrated. However, the subject matter described herein is not limited to using separate blocking devices for each monitored network monitor port 106. For example, a single blocking device with multiple ports may block the signals from monitor port 106 to multiple monitored networks.

In FIG. 2, blocking devices 202 and 204 are show as inline devices separate from optical couplers 114 and 116. In an alternate embodiment, blocking devices 202 and 204 may be integrated within optical couplers 114 and 116 to allow optical signals from the network ports to pass to the monitor port and block the flow of optical traffic from the monitor port to the network ports.

It will be understood that various details of the presently disclosed subject matter may be changed without departing from the scope of the presently disclosed subject matter. Furthermore, the foregoing description is for the purpose of illustration only, and not for the purpose of limitation.

What is claimed is:

1. A secure optical network tap comprising:
first and second network ports for bidirectional exchange of optical signals;
at least one monitor port for monitoring optical signals received on the first and second network ports;
first and second optical couplers coupled to the first and second network ports for bidirectional exchange of the monitored optical signals between the network ports and between the network ports and the monitor port; and
at least one one-way optical blocking device for preventing the flow of optical signals from the at least one monitor port to the first and second network ports and for allowing the monitored optical signals to flow from the optical couplers to the at least one monitor port.

2. The secure optical network tap of claim 1 wherein the at least one one-way optical blocking device comprises first and second optical isolators.

3. The secure optical network tap of claim 2 wherein the first and second optical isolators each comprise an input port connected to one of the optical couplers, an output port connected to the monitor port, a beam splitter connected between the input and output ports, a quarter wave plate optically coupled to the beam splitter, and a mirror for reflecting signals output from the quarter wave plate back to the beam splitter and to the output port.

4. The secure optical network tap of claim 1 wherein the at least one one-way optical blocking device comprises first and second optical circulators.

5. The secure optical network tap of claim 4 wherein the first and second optical circulators each comprise an input port coupled to one of the network ports, an output port connected to the at least one monitor port, an unterminated port for reflecting the monitored optical signals received on the input port to the output port and a circulator connected between the input and output ports for circulating the reflected optical signals to the output port and for preventing the flow of optical signals from the monitor port to the network ports.

6. A method for secure optical network tapping, the method comprising:
receiving optical signals at first and second network ports of an optical network tap;
providing the optical signals received by the network ports to first and second optical couplers;
blocking optical signals from a monitor port of the optical network tap from reaching the first and second network ports and allowing the optical signals from the network ports to pass from the optical couplers to the monitor port.

7. The method of claim 6 wherein blocking the optical signals includes blocking the optical signals using at least one one-way optical blocking device.

8. The method of claim 7 wherein the at least one one-way optical blocking device comprises first and second optical isolators.

9. The method of claim 8 wherein the first and second optical isolators each comprise an input port connected to one of the optical couplers, an output port connected to the monitor port, a beam splitter connected between the input and output ports, a quarter wave plate optically coupled to the beam splitter, and a mirror for reflecting signals output from the quarter wave plate back to the beam splitter and to the output port.

10. The method of claim 7 wherein the at least one one-way optical blocking device comprises first and second optical circulators.

11. The method of claim 10 wherein the first and second optical circulators each comprise an input port coupled to one of the network ports, an output port connected to the at least one monitor port, an unterminated port for reflecting the monitored optical signals received on the input port to the output port and a circulator connected between the input and output ports for circulating the reflected optical signals to the output port and for preventing the flow of optical signals from the monitor port to the network ports.
